(19) United States
(12) Patent Application Publication
(10) Pub. No.: US 2015/0341483 A1
(43) Pub. Date: Nov. 26, 2015

(54) User Mode Estimation on Mobile Device

(71) Applicant: Jian Zou, Chapel Hill, NC (US)

(72) Inventor: Jian Zou, Chapel Hill, NC (US)

(21) Appl. No.: 14/285,287

(22) Filed: May 22, 2014

(51) Int. Cl. H04M 1/725

(52) U.S. Cl. CPC H04M 1/72569

(57) ABSTRACT

Methods, program products, and systems of user mode estimation on mobile device are disclosed. For example, a method includes: collecting one or more information items on a mobile device; determining whether or not a condition related to a person substantially collocated with the device is true; performing, in response to the determination of said condition, a predetermined task. The condition can be determined to be true when and only when the person is determined to be in a predetermined mode at a given time.

### TECHNICAL FIELD

Some embodiments are related to mobile computerized device.

### BACKGROUND

The activity of a person at a given time can be classified into one of two or more predefined modes, for example, sleeping mode and wakeful mode. The wakeful mode can be further divided into more granular ones. For example, it can be divided based on physical movement of the person, such as not moving (being still), shaking, walking, running, biking, driving a motorized vehicle, or flying. Alternatively, it can be divided according to mental state of the user, such as working, studying, exercising, entertaining or others. Some modes can be defined clearly in terms of physiology, such as sleeping mode and wakeful mode. For many other modes, their exact scopes and boundaries can vary, depending on the purpose of the classification.

Determining the mode a person is in among two or more possibilities at a given time is helpful in understanding her behavior and intention around that time. This understanding is especially useful to a mobile device used by the person. If the device can accurately estimate the mode that its carrying user is in, the device can use the definition and characteristics of the mode to configure itself, control applications running on the device, or control other devices to better satisfy the needs of the user. For example, knowing the mode the user is currently in, the device can give priority to tasks more relevant to the user in that mode and postpone or shutdown not relevant tasks. For instance, when the user is estimated to be in sleeping mode, a task of turning the screen on and displaying some visual information can be postponed by the device as it is likely that the visual display on the screen would not be watched by the user while he is in sleeping mode. The device can also mute the speaker on the device for non-critical incoming phone calls in order not to disturb the user while she is in sleeping mode.

Further more, the device can store a time series of estimated modes and the user's interaction with the device during those modes persistently. The device can analyze that time series to recognize patterns in the activities of the user and her interactions with the device. Recognition of those patterns can enable the device to learn the habits of the user, to make predictions about the future activities of the user and her future interactions with the device. The device can then use those predictions as a basis to make choices in configuring the device itself, in controlling the applications running on the device, or in controlling other connected devices, to better meet the projected future demand of the user.

A mobile device carried by a user in close physical proximity can be well positioned to estimate the mode the user is in. A mobile device is often equipped with a variety of sensors, for example, a touch screen, a microphone, a camera, a wireless transceiver, an accelerometer, an gyroscope, a magnetometer, a thermometer, or the like. Those sensors can be configured to collect information about the device itself and the surroundings of the device. When the device is located in close physical proximity of its user, the information collected on the device is likely to contain information related to the user and thus can be used to estimate the mode the user is in. For example, when the device is substantially collocated with the user, ambient sound level detected on the device can be highly correlated with the ambient sound level detected by the user. In that case, the ambient sound level detected on the device can contain information about the mode the user is in and can be used to estimate that mode. In another example, when the device is substantially collocated with the user, the estimated geographic location of the device can be very close to the geographic location of the user, thus providing information about the mode the user is in.

### SUMMARY

Methods, program products and systems of user mode estimation on mobile device are disclosed. For example, a method can include: collecting one or more information items on a mobile device; determining whether or not a condition related to a person substantially collocated with the device is true; and performing, in response to the determination of said condition, a predetermined task.

The techniques described in this specification can be implemented to achieve the following exemplary advantages.

In some embodiments, they can enable a mobile device to more effectively utilize available resources, such as computing resource, communications resources and power, to satisfy the requirements of the user, without direct attention from the user. In some embodiments, they can enable a mobile device to provide a more personalized and thus more satisfying user experience to the user.

The details of one or more embodiments of user mode estimation on mobile device are set forth in the accompanying drawings and the description below. Other aspects, features, advantages and requirements will become apparent from the description, the drawings and the claims.

### BRIEF DESCRIPTION OF DRAWINGS

FIG. 1 is a block diagram providing an overview of exemplary techniques of user mode estimation on mobile device.

FIG. 2 is a flowchart of an exemplary process for determining prior likelihood of each possible user mode for a given time.

FIG. 3 is a flowchart of an exemplary process for determining conditional probability of ambient sound level for a given mode.

FIG. 4 is a flowchart illustrating an exemplary process of applying the result of user mode estimation in managing a mobile device, computer programs running on the device and other remote computing devices and apparatus.

FIG. 5 is a block diagram illustrating functional components of an exemplary user mode estimation system.

### DETAILED DESCRIPTION

### Overview of User Mode Estimation on Mobile Device

In the following detailed description, numerous specific details are disclosed to provide a thorough understanding of some embodiments. However, it will be understood by persons of ordinary skills in the art that some embodiments may be practiced without those specific details. In some instances, well-known methods, definitions, procedures, components units have not been described in detail in order not to obscure the discussion.

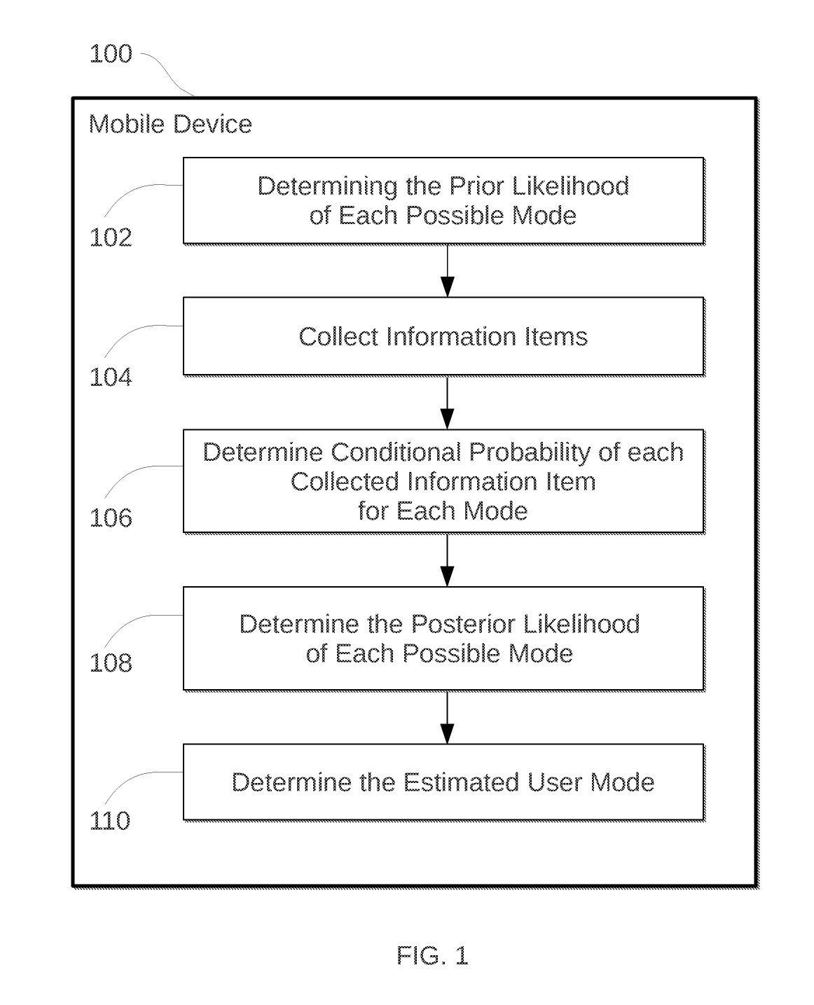

FIG. 1 is a block diagram providing an overview of exemplary techniques of user mode estimation on mobile device.

Mobile device 100 can determine 102 the prior likelihood of each possible mode a user of device 100 can be in at the time. In some embodiments, all possible modes are predetermined and they are defined in such a way that the user can be in one and only one of those modes at any time. In some embodiments, there are only two possible modes: sleeping mode and wakeful mode. In some embodiments, possible modes can include: sleeping mode, working mode, commuting mode, wakeful-resting mode, shopping mode, exercising mode, entertaining mode and a non-of-the-above mode which includes all other activities.

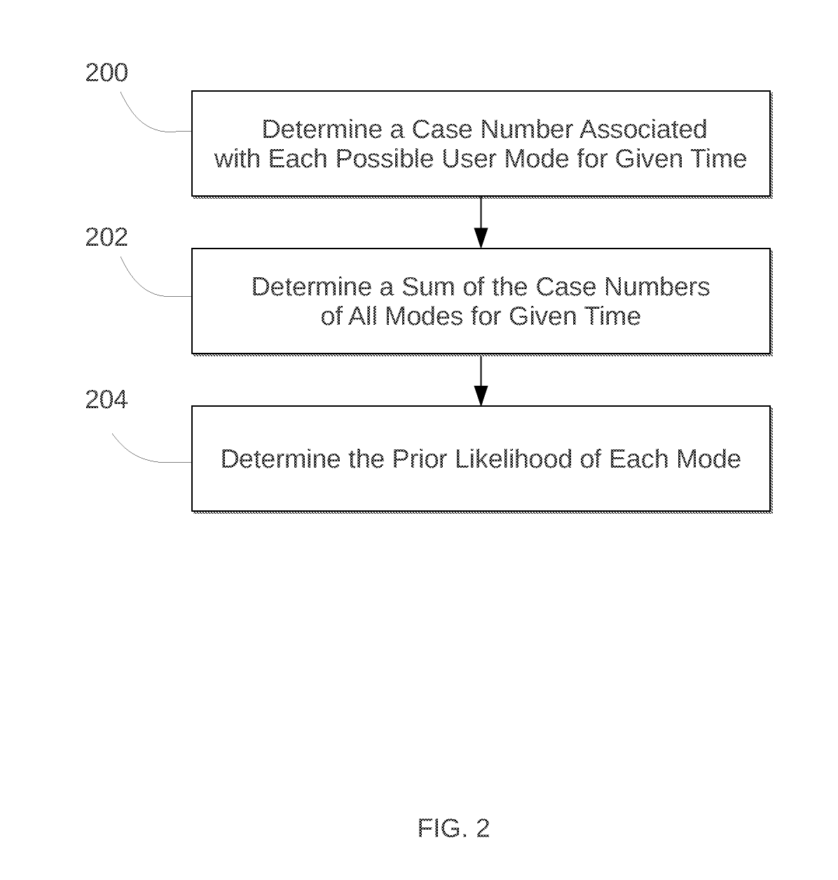

In some embodiments, prior likelihood of a mode can be a likelihood that the user is in that mode, before considering any information items collected on device 100 at or around the time. In some embodiments, prior likelihood of a mode can be a numerical value between 0 and 1, inclusive of both 0 and 1. In some embodiments, the prior likelihood of a mode can contain only information about the user, and can not be affected in anyway by device 100 itself, or any measurements taken on device 100. Since many people more or less follow a calendar and a sleep-wake cycle, in some embodiments, time can be an important piece of information in user mode estimation. In some embodiments where the time for which the user mode is estimated, is already known in step 102, prior likelihood can take time into account. The prior likelihoods can be stored persistently in non-transitory storage medium on device 100 and be retrieved from device 100 when needed. In some embodiments, they can be stored remotely on another different computing device and retrieved by device 100 over a network. In some embodiments, they can be calculated by device 100 based on information retrieved from device 100 or received from another different computing device over a network. Further details of an exemplary prior likelihood determination process will be discussed below in reference to FIG. 2.

Device 100 can collect 104 information items on device 100. In some embodiments, the items can include item about the device 100, for example, whether or not a phone call is ongoing on device 100, the other phone number in the phone call and contact information stored on device 100 associated with that phone number if one is ongoing, whether or not a user is interacting with device 100, whether or not the screen of device 100 is on, one or more acceleration measurements taken on device 100 and related statistics, one or more angular velocity measurements taken on device 100 by a gyroscope or equivalent sensors and related statistics, orientation and positioning of device 100 or the like. In some embodiments, the information items can also include item about the surroundings of device 100, for example, the ambient sound level measured on device 100, the geographic location of device 100, identification information and signal strengths of wireless signal emitters whose signals can be detected on device 100 (e.g. cell towers, wireless routers and navigation satellites), one or more measurements of an external magnetic field detected on device 100 and related statistics, ambient air temperature measured on device 100, ambient air pressure measured on device 100, ambient air humidity level measured on device 100, pressure exerted on a touch screen of device 100, luminance as measured by a photoelectric sensor on device 100, an intensity of an ionizing radiation measured on device 100, concentration of a particular chemical element or compound (e.g. carbon dioxide) measured on device 100 or the like.

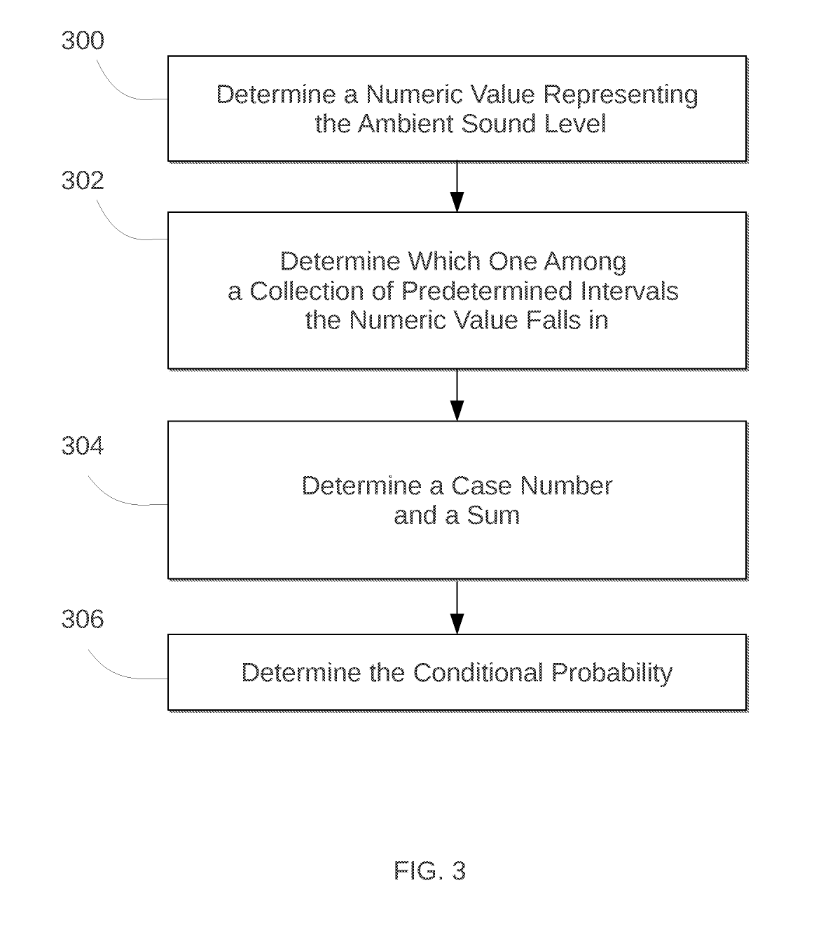

Device 100 can determine 106 the conditional probability or probability density of each collected information item for each possible mode. Conditional probability or probability density of a collected information item for a mode can mean the probability or probability density that the collected information items have the specific values as collected, when the user is in the mode. Conditional probability or probability density can be dependent on the information item being collected, the scope and boundaries of the mode, the specific user of device 100, the sensors on device 100 used to collect the information item, and the way the information item is collected. For example, the conditional probability distribution of ambient sound level measured on device 100 when the user of device 100 is in sleeping mode can be different from that of ambient air pressure when the user is in wakeful mode. In another example, the conditional probability density function of geographic location of a first mobile device when a user of the first device is in working mode can be different from the conditional probability distribution of geographic location of a second different mobile device when a user of the second device is in working mode, especially when those two users do not share the same work place. Further details of an exemplary conditional probability determination process for ambient sound level for a given mode will be described below in reference to FIG. 3.

Device 100 can determine 108 the posterior likelihood of each possible mode, using the prior likelihoods of all possible mode as determined in 102 and the conditional probabilities as determined in 106.

Posterior likelihood of a mode can be a likelihood that the user is in that mode, after considering all information items collected on device 100 at or around that time. In some embodiments, the process of determining the posterior likelihood of each possible mode can be based on Bayes' theorem in probability theory. In some embodiments, one exemplary process of 108 can be described as follows. The user can be in one and only one of two mutually exclusive modes, sleeping mode and wakeful mode, at the given time. The prior likelihood of sleeping mode can be determined to be p₁. The prior likelihood of wakeful mode can be determined to be p₂=1−p₁. One information item, the ambient sound level, can be collected on device 100. The ambient sound level is measured to be s. The conditional probability of ambient sound level being s when the user is in sleeping mode can be determined to be c₁. The conditional probability of ambient sound level being s when the user is in wakeful mode can be determined to be c₂. The posterior likelihood of sleeping mode q₁ can be determined to be

$${q}_{1} = \frac{{p}_{1} \times {c}_{1}}{( {p}_{1} \times {c}_{1} + {p}_{2} \times {c}_{2} )} .$$

The posterior likelihood of wakeful mode can be determined to be q₂=1q₁.

In some embodiments, two or more information items can be collected on device 100. In some embodiments, one exemplary process of 108 can be described as follows. The user can be in one and only one of two mutually exclusive modes, sleeping mode and wakeful mode, at the given time. The prior likelihood of sleeping mode can be determined to be p₁. The prior likelihood of wakeful mode can be determined to be p₂=1−p₁. Two information items, the ambient sound level and the acceleration of device 100 measured by a relevant sensor on device 100, can be collected on device 100. The ambient sound level is measured to be s. The conditional probability of ambient sound level being s when the user is in sleeping mode can be determined to be c₁. The conditional probability of ambient sound level being s when the user is in wakeful mode can be determined to be c₂. The acceleration of device 100 can be measured to be a. The conditional probability of the acceleration being a when the user is in sleeping mode can be determined to be d₁. The conditional probability of the acceleration being a when the user is in wakeful mode can be determined to be d₂.

The posterior likelihood of sleeping mode and wakeful mode can be determined as follows. An intermediate likelihood of sleeping mode r₁ can be determined to be

$${r}_{1} = \frac{{p}_{1} \times {c}_{1}}{( {p}_{1} \times {c}_{1} + {p}_{2} \times {c}_{2} )} .$$

An intermediate likelihood of wakeful mode r₂ can be determined to be r₂=1−r₁. The posterior likelihood of sleeping mode can be determined to be

$${q}_{1} = \frac{{r}_{1} \times {d}_{1}}{( {r}_{1} \times {d}_{1} + {r}_{2} \times {d}_{2} )} .$$

The posterior likelihood of wakeful mode can be determined to be q₂=1−q₁.

In some embodiments, the number of possible modes can be greater than two. In some embodiments, one exemplary process of 108 can be described as follows. The user can be in one and only one of three mutually exclusive modes, sleeping mode, wakeful-working mode and wakeful-not-working mode at the given time. The prior likelihood of sleeping mode can be determined to be p₁. The prior likelihood of wakeful-working mode can be determined to be p₂. The prior likelihood of wakeful-not-working mode can be determined to be p₃=1−p₁−p₂. Two information items, the ambient sound level and the geographic location of device 100, can be collected on device 100. The ambient sound level is measured to be s. The conditional probability of ambient sound level being s when the user is in sleeping mode can be determined to be c₁. The conditional probability of ambient sound level being s when the user is in wakeful-working mode can be determined to be c₂. The conditional probability of ambient sound level being s when the user is in wakeful-not-working mode can be determined to be c₃. The geographic location of device 100 can be determined to be g. The conditional probability density of the geographic location being g when the user is in sleeping mode can be determined to be d₁. The conditional probability density of the geographic location being g when the user is in wakeful-working mode can be determined to be d₂. The conditional probability density of the geographic location being g when the user is in wakeful-not-working mode can be determined to be d₃.

In some embodiments, the conditional probability density of the geographic location being g when the user is in sleeping mode, d₁, can be determined based on the estimated distance between the geographic location g and a geographic location or area or a collection of geographic locations or areas where the user can be located when the user is in sleeping mode, such as her home. Likewise, the conditional probability density of the geographic location being g when the user is in wakeful-working mode, d₂, can be determined based on the estimated distance between geographic location g and a geographic location or area or a collection of geographic locations or areas where the user can be located when the user is in wakeful-working mode, such as her workplace. In some embodiments, the conditional probabilities density of the geographic location being g when the user is in a given mode can be determined based on a Gaussian (or normal) distribution with respect to a distance between the geographic location g and a geographic location or area or a collection of geographic locations or areas where the user can be located when the user is in that given mode.

An intermediate likelihood of sleeping mode r₁ can be determined to be

$${r}_{1} = \frac{{p}_{1} \times {c}_{1}}{( {p}_{1} \times {c}_{1} + {p}_{2} \times {c}_{2} + {p}_{3} \times {c}_{3} )} .$$

An intermediate likelihood of wakeful-working mode r₂ can be determined to be

$${r}_{2} = \frac{{p}_{2} \times {c}_{2}}{( {p}_{1} \times {c}_{1} + {p}_{2} \times {c}_{2} + {p}_{3} \times {c}_{3} )} .$$

An intermediate likelihood of wakeful-not-working mode r₃ can be determined to be r₃=1−r₁−r₂. The posterior likelihood of sleeping mode can be determined to be

$${q}_{1} = \frac{{r}_{1} \times {d}_{1}}{( {r}_{1} \times {d}_{1} + {r}_{2} \times {d}_{2} + {r}_{3} \times {d}_{3} )} .$$

The posterior likelihood of wakeful-working mode can be determined to be

$${q}_{2} = \frac{{r}_{2} \times {d}_{2}}{( {r}_{1} \times {d}_{1} + {r}_{2} \times {d}_{2} + {r}_{3} \times {d}_{3} )} .$$

The posterior likelihood of wakeful-not-working mode can be determined to be q₃=1−q₁−q₂.

Device 100 can determine 110 the estimated user mode, based on the posterior likelihoods of modes as determined in 108. In some embodiments, device 100 can determine the estimated user mode to be the one with highest posterior likelihood among all possible modes. In some embodiments, device 100 can determine the estimated user mode to be the one whose posterior likelihood exceeds a predetermined threshold, e.g. 50%.

### Prior Likelihood

FIG. 2 is a flowchart of an exemplary process for determining prior likelihood of each possible user mode for a given time.

Device 100 can determine 200 a case number associated with each possible user mode for the given time. In some embodiments, the case number for each mode can be a positive integer to avoid zero prior likelihood for some user mode. In some embodiments, the case number associated with the same user mode can be different at different time. For example, the case number associated with sleeping mode for the noon of a day can be different from the case number associated with sleeping mode for the midnight of the same day.

In some embodiments, the case number for each mode can be provided by a user of device 100 and stored on device 100 before operation 200. In some embodiments, device 100 can retrieve the case number from non-transitory storage medium on device 100. In some embodiments, the case number for each mode can be determined using information provided by a user of device 100 specifically for this purpose, such as the user's answer to a question about his lifestyle. In some embodiments, the case number for each mode can be calculated using information about the user that is available on device 100 or on other connected computing devices, such as the appointments planner, call logs, audio or video recordings on device 100, or the like. In some embodiments, the case number for each mode stored on device 100 can be incremented once device 100 is estimated to be in the corresponding mode at a time related to the given time, e.g. same time in a day.

Device 100 can determine 202 a sum of the case numbers of all modes for the given time.

Device 100 can determine 204 the prior likelihood of each mode to be the result of dividing the case number of the mode by the sum.

### Conditional Probability

FIG. 3 is a flowchart of an exemplary process for determining conditional probability of ambient sound level for a given mode.

Device 100 can determine 300 a numeric value representing the ambient sound level, as detected and measured by an acoustic-to-electric transducer or sensor on device 100.

Device 100 can determine 302 which one among a collection of predetermined intervals the numeric value falls in.

Device 100 can determine 304 a case number associated with that interval and the given mode and a sum of all case numbers that are associated with intervals in the collection and the given mode.

In some embodiments, the case number associated with the interval and the given mode can be an positive integer to avoid zero conditional probability for some ambient sound levels. In some embodiments, device 100 can retrieve the case number from non-transitory storage medium on device 100. In some embodiments, the case number associated with an interval can be determined by a training process performed on device 100. One exemplary training process can be described as follows. Device 100 can take a certain number of ambient sound level measurements using related sensors on device 100 when the user is known to be in the given mode. For each interval in the collection of intervals, device 100 can determine the number of times, i.e. frequency, of an ambient sound level measurement falling into that interval. Device 100 can determine the case number associated with that interval to be the corresponding frequency.

Device 100 can determine 306 the conditional probability of the ambient sound level for the given mode to be the result of dividing the case number by the sum.

### Application of Estimated User Mode

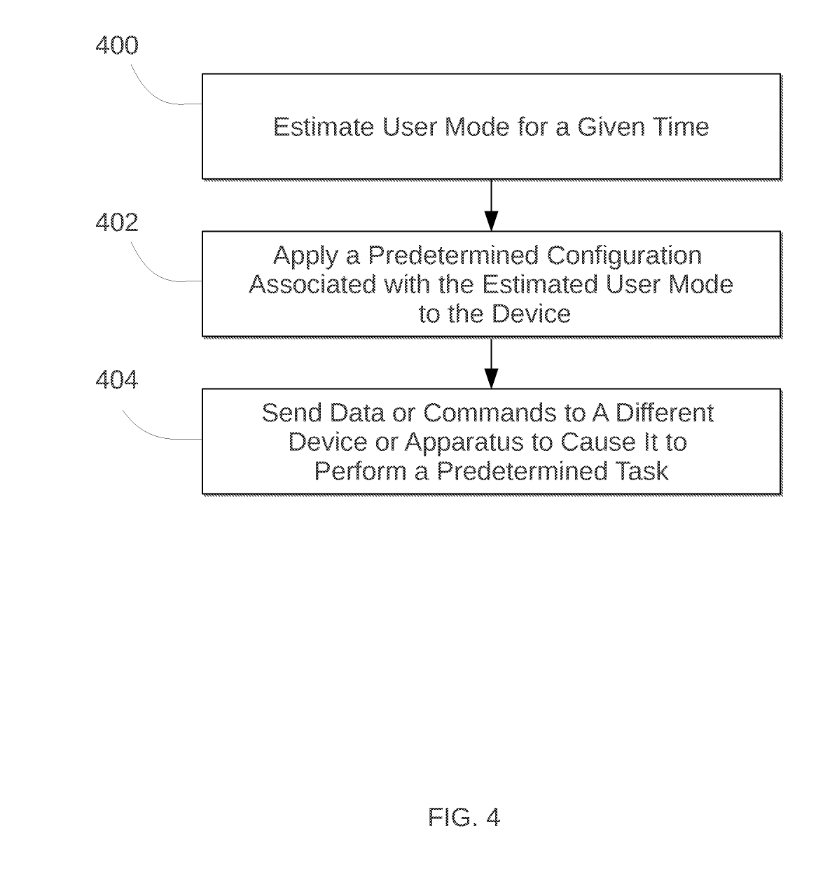

FIG. 4 is a flowchart illustrating an exemplary process of applying the result of user mode estimation in managing a mobile device, computer programs running on the device and other remote computing devices and apparatus.

Device 100 can estimate 400 user mode for a given time. Further details of 400 have been described above in reference to FIG. 1. As an example, device 100 can estimate that a user of device 100 is in sleeping mode at the time.

Device 100 can apply 402 a predetermined configuration of device 100 associated with the estimated user mode to device 100.

In some embodiments, one exemplary process of 402 can be described as follows. Based on a predetermined configuration associated with sleeping mode, device 100 can shutdown a visual gaming program still running on device 100. Device 100 can start a sleeping quality detection program on device 100 if it is not already running. Device 100 can start a power conservation feature of its power management program. Device 100 can switch an operation system program running on device 100 from normal mode to a different more power efficient mode. Device 100 can turn off power and disable some sensors on device 100, such as accelerometer, and reconfigure the device to run without those sensors. Device 100 can turn on the power to some sensors and enable them, such as an acoustic-to-electric sensor, to detect ambient sound level for sleep quality detection purpose and for continued user mode monitoring. Device 100 can switch one or more processors on device 100 from normal mode to a different more power efficient mode. Device 100 can postpone a scheduled software update alert. Device 100 can cancel a scheduled user movement detection task. Device 100 can mute speaker or vibrators of device 100.

Device 100 can send 404 data or commands over a communications network to a remote different computing device or an apparatus to cause it to perform a predetermined task.

In some embodiments, for example, device 100 can send a command over local wireless area network to all connected light fixtures to cause them to turn off themselves. In some embodiments, device 100 can send a command over local wireless area network to a connected home security system to cause it to be armed. In some embodiments, device 100 can send a command over local wireless area network to all connected personal computers to cause them to shutdown to conserve power. In some embodiments, device 100 can send a command over local wireless area network to all connected appliance to cause them to shutdown or enter a power-conservation mode. In some embodiments, device 100 can send a command over cellular network to a remote computing device or a server to cause it to perform a predetermined task. In some embodiments, device 100 can send messages over cellular network to a predetermined group of interested mobile devices, notifying the sleeping mode of the user.

### User Mode Estimation System

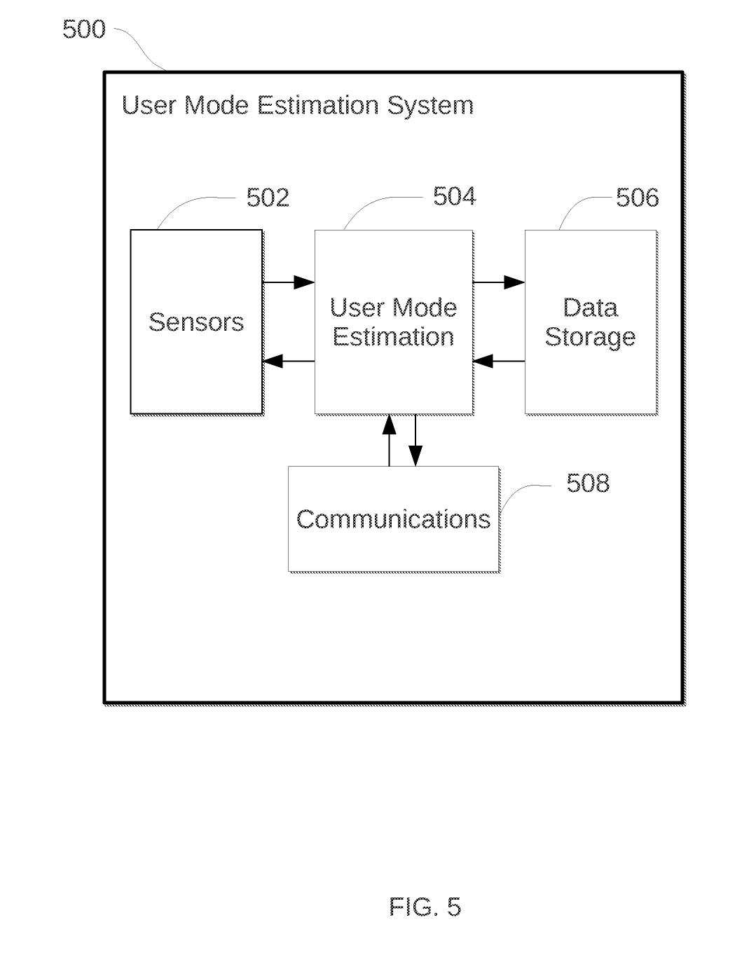

FIG. 5 is a block diagram illustrating functional components of an exemplary user mode estimation system. User mode estimation system 500 can be a component of device 100 as described above in reference to FIG. 1.

System 500 can include data storage unit 506. Unit 506 can be a non-transitory data storage component of system 500 that is configured to store prior likelihood of each possible user mode, conditional probabilities of information items in each mode, and predetermined configurations of device 100 for each mode, commands and data associated with each mode, as well as other related data.

System 500 can include sensors unit 502. Unit 502 is part of system 500 which is configured to detect and collect information items about device 100 and its surroundings. Unit 502 can include at least one of: a touch screen, a microphone, a digital camera, a wireless transceiver, an accelerometer, an gyroscope, a magnetometer, a thermometer, an acoustic-to-electric transducer or sensor, a receiver of a navigation satellite system, a humidity sensor, an air pressure sensor, a light sensor, a proximity sensor, and the like.

System 500 can include user mode estimation unit 504. Unit 504 can contain one or more processors and instructions to run the processors to perform operations 102, 104, 106, 108, 110 as described in details in reference to FIG. 1, in collaboration with Unit 506 and Unit 502.

System 500 can include communications unit 508. Unit 508 can be a component of system 500 that is configured to communicate with other different devices or apparatus over a wired or wireless communications network. Unit 508 can contain one or more wireless transceivers.

1-15. (canceled)

16. A method implemented on a mobile device, comprising:
collecting one or more information items on said mobile device at or around a given time;
determining a mode that the activity of a person in close physical proximity with said device is in at said time, using one or more collected information items, among a collection of possible predetermined modes; and
performing, in response to the mode determination, a predetermined task.

17. The method of claim 16, wherein said information items comprise at least one of:
said given time;
time between the start of a predefined time interval and said given time;
whether or not a phone call is ongoing on said device;
the other phone number in said phone call;
contact information associated with said other phone number;
whether or not said person is interacting with said device;
whether or not the screen of said device is on;
one or more acceleration measurements taken on said device;
one or more statistics related to said acceleration measurements;
one or more angular velocity measurements taken on said device;
one or more statistics related to said angular velocity measurements;
orientation of said device;
ambient sound level measured on said device;
estimated geographic location of said device;
identification information and signal strengths of wireless signal emitters whose signals can be detected on said device;
one or more measurements of an external magnetic field detected on said device;
one or more statistics related to said measurements of said external magnetic field;
ambient air temperature measured on said device;
ambient air pressure measured on said device;
ambient air humidity level measured on said device;
pressure exerted on a touch screen of said device;
luminance measured by a photoelectric sensor on said device;
the intensity of an ionizing radiation measured on said device;
ambient concentration of a particular chemical element or compound measured on said device; or
any physiological measurements of said person recorded on said device.

18. The method of claim 16, wherein said predetermined task comprises at least one of:
shutdown of a computer program or a feature of a computer program running on said device;
starting a computer program or a feature of a computer program on said device;
switching a computer program running on said device from one operation mode, to another different operation mode;
switching said device from one configuration, to another different configuration;
enabling a component of said device;
disabling a component of said device;
switching a component of said device, from one operation mode to another different operation mode;
postponing a scheduled task on said device;
canceling a scheduled task on said device;
setting up a scheduled task on said device;
causing another different computing device to perform another different predetermined task; or
causing another different apparatus to perform another different predetermined task.

19. The method of claim 16, wherein determining a mode that the activity of a person in close physical proximity with said device is in at or around said time, using one or more collected information items, among a collection of possible predetermined modes comprises:
determining a prior likelihood for each possible predetermined mode;
determining a conditional probability or probability density of each collected information item for each said mode;
determining the posterior likelihoods of one or more said possible predetermined modes using all prior likelihoods and all conditional probabilities or probability densities as determined; and
determining the mode that the activity of said person in close physical proximity with said device is in at or around said time based on said posterior likelihoods.

20. The method of claim 19, wherein determining the posterior likelihoods of one or more said possible predetermined modes using all prior likelihoods and all conditional probabilities or probability densities as determined comprises:
determining the posterior likelihoods of one or more said possible predetermined modes using all prior likelihoods and all conditional probabilities or probability densities as determined, according to Bayes' theorem.

21. The method of claim 19, wherein determining a prior likelihood for each possible predetermined mode comprises:
determining a case number associated with each said mode;
determining a sum of the case numbers of all possible predetermined modes; and
determining the prior likelihood of each said mode to be the result of dividing the case number associated with the mode by the sum.

22. The method of claim 19, wherein determining a conditional probability or probability density of each collected information item for each said mode comprises:
determining a value representing each collected information item;
determining a set among a collection of predetermined sets of values said value belongs to;
for each said mode, determining a case number associated with said set and a sum of all case numbers that are associated with all sets in the collection; and
for each said mode, determine the conditional probability of said collected information item to be the result of dividing said case number associated with said set by said sum.

23. A computer program product, tangibly stored on a non-transitory medium and configured to cause a mobile device to perform operations comprising:
collecting one or more information items on said mobile device at or around a given time;
determining a mode that the activity of a person in close physical proximity with said device is in at said time, using one or more collected information items, among a collection of possible predetermined modes; and
performing, in response to the mode determination, a predetermined task.

24. The product of claim 23, wherein said information items comprise at least one of:
said given time;
time between the start of a predefined time interval and said given time;
whether or not a phone call is ongoing on said device;
the other phone number in said phone call;
contact information associated with said other phone number;
whether or not said person is interacting with said device;
whether or not the screen of said device is on;
one or more acceleration measurements taken on said device;
one or more statistics related to said acceleration measurements;
one or more angular velocity measurements taken on said device;
one or more statistics related to said angular velocity measurements;
orientation of said device;
ambient sound level measured on said device;
estimated geographic location of said device;
identification information and signal strengths of wireless signal emitters whose signals can be detected on said device;
one or more measurements of an external magnetic field detected on said device;
one or more statistics related to said measurements of said external magnetic field;
ambient air temperature measured on said device;
ambient air pressure measured on said device;
ambient air humidity level measured on said device;
pressure exerted on a touch screen of said device;
luminance measured by a photoelectric sensor on said device;
the intensity of an ionizing radiation measured on said device;
ambient concentration of a particular chemical element or compound measured on said device; or
any physiological measurements of said person recorded on said device.

25. The product of claim 23, wherein said predetermined task comprises at least one of:
shutdown of a computer program or a feature of a computer program running on said device;
starting a computer program or a feature of a computer program on said device;
switching a computer program running on said device from one operation mode, to another different operation mode;
switching said device from one configuration, to another different configuration;
enabling a component of said device;
disabling a component of said device;
switching a component of said device, from one operation mode to another different operation mode;
postponing a scheduled task on said device;
canceling a schedule task on said device;
causing another different computing device to perform another different predetermined task; or
causing another different apparatus to perform another different predetermined task.

26. The product in claim 23, wherein determining a mode that the activity of a person in close physical proximity with said device is in at or around said time, using one or more collected information items, among a collection of possible predetermined modes comprises:
determining a prior likelihood for each possible predetermined mode;
determining a conditional probability or probability density of each collected information item for each said mode;
determining the posterior likelihoods of one or more said possible predetermined modes using all prior likelihoods and all conditional probabilities or probability densities as determined; and
determining the mode that the activity of said person in close physical proximity with said device is in at or around said time based on said posterior likelihoods.

27. The product in claim 26, wherein determining the posterior likelihoods of one or more said possible predetermined modes using all prior likelihoods and all conditional probabilities or probability densities as determined comprises:
determining the posterior likelihoods of one or more said possible predetermined modes using all prior likelihoods and all conditional probabilities or probability densities as determined, according to Bayes' theorem.

28. The product in claim 26, wherein determining a prior likelihood for each possible predetermined mode comprises:
determining a case number associated with each said mode;
determining a sum of the case numbers of all possible predetermined modes; and
determining the prior likelihood of each said mode to be the result of dividing the case number associated with the mode by the sum.

29. The product in claim 26, wherein determining a conditional probability or probability density of each collected information item for each said mode comprises:
determining a value representing each collected information item;
determining a set among a collection of predetermined sets of values said value belongs to;
for each said mode, determining a case number associated with said set and a sum of all case numbers that are associated with all sets in the collection; and
for each said mode, determine the conditional probability of said collected information item to be the result of dividing said case number associated with said set by said sum.

30. A system, comprising:
a sensors units configured to collect one or more information items about a mobile device, the surroundings of said device or physiological measurement of a person;
a data storage unit configured to store data persistently; and
a user mode estimation unit comprising:
one or more processors configured to perform:
collecting one or more information items on said mobile device;
determining a mode that the activity of a person in close physical proximity with said device is in at said time, using one or more collected information items, among a collection of possible predetermined modes; and
performing, in response to the mode determination, a predetermined task.

31. The system of claim 30, wherein said information items comprise at least one of:
said given time;
time between the start of a predefined time interval and said given time;
whether or not a phone call is ongoing on said device;
the other phone number in said phone call;
contact information associated with said other phone number;
whether or not said person is interacting with said device;
whether or not the screen of said device is on;
one or more acceleration measurements taken on said device;
one or more statistics related to said acceleration measurements;
one or more angular velocity measurements taken on said device;
one or more statistics related to said angular velocity measurements;
orientation of said device;
ambient sound level measured on said device;
estimated geographic location of said device;
identification information and signal strengths of wireless signal emitters whose signals can be detected on said device;
one or more measurements of an external magnetic field detected on said device;
one or more statistics related to said measurements of said external magnetic field;
ambient air temperature measured on said device;
ambient air pressure measured on said device;
ambient air humidity level measured on said device;
pressure exerted on a touch screen of said device;
luminance measured by a photoelectric sensor on said device;
the intensity of an ionizing radiation measured on said device;
ambient concentration of a particular chemical element or compound measured on said device; or
any physiological measurements of said person recorded on said device.

32. The system of claim 30, wherein said predetermined task comprises at least one of:
shutdown of a computer program or a feature of a computer program running on said device;
starting a computer program or a feature of a computer program on said device;
switching a computer program running on said device from one operation mode, to another different operation mode;
switching said device from one configuration, to another different configuration;
enabling a component of said device;
disabling a component of said device;
switching a component of said device, from one operation mode to another different operation mode;
postponing a scheduled task on said device;
canceling a schedule task on said device;
causing another different computing device to perform another different predetermined task; or
causing another different apparatus to perform another different predetermined task.

33. The system of claim 30, wherein determining a mode that the activity of a person in close physical proximity with said device is in at or around said time, using one or more collected information items, among a collection of possible predetermined modes comprises:
determining a prior likelihood for each possible predetermined mode;
determining a conditional probability or probability density of each collected information item for each said mode;
determining the posterior likelihoods of one or more said possible predetermined modes using all prior likelihoods and all conditional probabilities or probability densities as determined; and
determining the mode that the activity of said person in close physical proximity with said device is in at or around said time based on said posterior likelihoods.

34. The system of claim 33, wherein determining the posterior likelihoods of one or more said possible predetermined modes using all prior likelihoods and all conditional probabilities or probability densities as determined comprises:
determining the posterior likelihoods of one or more said possible predetermined modes using all prior likelihoods and all conditional probabilities or probability densities as determined, according to Bayes' theorem.

35. The system of claim 33, wherein determining a prior likelihood for each possible predetermined mode comprises:
determine a case number associated with each said mode for said time;
determine a sum of the case numbers of all possible predetermined modes for said time; and
determine the prior likelihood of each said mode to be the result of dividing the case number of the mode by the sum.

36. The system of claim 33, wherein determining a conditional probability or probability density of each collected information item for each said mode comprises:
determining a value representing each collected information item;
determining a set among a collection of predetermined sets of values said value belongs to;
for each said mode, determining a case number associated with said set and a sum of all case numbers that are associated with all sets in the collection; and
for each said mode, determine the conditional probability of said collected information item to be the result of dividing said case number associated with said set by said sum.
